(19) United States
(12) Patent Application Publication
(10) Pub. No.: US 2012/0310575 A1
(43) Pub. Date: Dec. 6, 2012

(54) Inspection Method for Pixel Array and Inspection Apparatus Thereof

(76) Inventor: Wen-Da Cheng, Guangdong (CN)

(21) Appl. No.: 13/265,870

(22) PCT Filed: Jun. 19, 2011
(86) PCT No.: PCT/CN11/75907

§ 371 Date: Oct. 22, 2011

(30) Foreign Application Priority Data
Jun. 6, 2011 (CN) 201110149500.8

(51) Int. Cl. G06F 19/00

(52) U.S. Cl. 702/82; 702/81

(57) ABSTRACT

The present invention provides an inspection method for a pixel array and an inspection apparatus thereof. The inspection method firstly charges a sample pixel area containing a flawed pixel unit and normal pixel units with different testing voltages, then creates a lookup table of brightness threshold value according to the brightness values of the pixel units under those testing voltages ; and then charges a pixel area under test when inspecting the pixel area under test, selects a suitable brightness threshold value from the lookup table according to the current voltage value and the brightness value thereof, and then determines if pixel units of the pixel area under test have any defect according to the brightness threshold value. Therefore, the present invention reduces defect-identifying error and enhances inspection accuracy.

### FIELD OF THE INVENTION

The present invention relates to an inspection method and an inspection apparatus for liquid crystal panels, and more particularly to an inspection method for a pixel array and an inspection apparatus thereof.

### BACKGROUND OF THE INVENTION

In a manufacturing process of liquid crystal panel, each stage requires an inspection step to ensure the yield of product. During producing a substrate having pixel arrays, the substrate needs to pass through an array inspection apparatus to check if each pixel pattern on the substrate has any flaw.

In the prior art, when inspecting pixel electrode flaws, a probe of the array inspection apparatus first charges the pixel electrodes of the pixel array, and then inspects the brightness of each pixel electrode. The apparatus then calculates the average brightness of the pixel electrodes in each specific area. The inspection apparatus then calculates the ratio of the brightness value of each pixel electrode to the average brightness and compares the ratio with a predetermined brightness threshold value of the array inspection apparatus. When the brightness ratio of a pixel electrode is smaller than the threshold value, the inspection apparatus then determines that the pixel electrode has a flaw.

However, the voltage input by the probe will decay due to impedance of conducting wires, that is the voltage received by the pixel electrode disposed on an output end of the conducting wires is lower than the voltage that the probe inputs. In the prior art, only one single brightness threshold value is applied as the criterion for flaw identify for the array inspection apparatus. But the same threshold value will not be suitable for pixel flaw inspection under different operation voltages since check error may occur or flaws cannot be indentified during the inspection process.

Hence, it is necessary to provide a pixel array inspection method and inspection apparatus thereof to overcome the problems existing in the conventional technology.

### SUMMARY OF THE INVENTION

The present invention provides a pixel array inspection method to solve the problem that check error may occur or flaws cannot be indentified during the pixel inspection process.

In view of the shortcoming of the prior art, a primary object of the invention is to provide a pixel array inspection method that creates an appropriate lookup table of brightness threshold value by collecting brightness values of the same flawed pixel under different operation voltages, so as to reduce check errors and increase inspection accuracy.

To achieve the above object, the present invention provides a pixel array inspection method having steps of:

S10: charging a sample pixel area containing flawed pixel units and normal pixel units with different testing voltages and creating and saving a lookup table of brightness threshold value according to the brightness value of each of the pixel units; and

S20: charging a pixel area under test and selecting a corresponding brightness threshold value from the lookup table according to the current voltage value and the brightness value of the pixel area under test to inspect the pixel area under test.

In one embodiment of the present invention, the step S10 includes steps of:

S11: selecting different testing voltages to charge the sample pixel area containing a flawed pixel unit and normal pixel units;

S12: detecting brightness of each of the pixel units in the sample pixel area under said different testing voltages to obtain brightness values of the flawed pixel unit and the normal pixel units;

S13: calculating brightness averages of all of the pixel units in the sample pixel area under said different testing voltages; and

S14: calculating ratios of the brightness value of the flawed pixel unit to the brightness averages and creating suitable brightness threshold values corresponding to the testing voltages according to the ratios, so as to create and save a lookup table of brightness threshold value.

In one embodiment of the present invention, the step S20 includes steps of:

S21: applying voltage to a pixel array under test;

S22: detecting brightness value of each pixel unit;

S23: calculating an average of brightness values of the pixel units in each pixel area;

S24: calculating a ratio of the brightness value of each pixel unit to the average;

S25: detecting voltage value of each pixel area under test;

S26: looking up a corresponding brightness threshold value from the lookup table saved in a saving module according to the voltage value of each pixel area under test; and

S27: comparing the ratio obtained from the step S24 with the brightness threshold value obtained from the step S26.

In one embodiment of the present invention, the brightness threshold value is larger than the ratio of the brightness value of the flawed pixel unit to the brightness average.

In one embodiment of the present invention, when the ratio is smaller than the brightness threshold value, the pixel unit corresponding to the ratio is a flawed pixel unit.

In one embodiment of the present invention, the brightness threshold value is smaller than the ratio of the brightness value of the flawed pixel unit to the brightness average.

In one embodiment of the present invention, when the ratio is larger than the brightness threshold value, the pixel unit corresponding to the ratio is a flawed pixel unit.

The present invention further provides a pixel array inspection method having steps of:

S11: selecting different testing voltages to charge a sample pixel area containing a flawed pixel unit and normal pixel units, and the testing voltages are within a range of voltage transmitted by a conducting wire connected to the sample pixel area;

S12: detecting brightness of each of the pixel units in the sample pixel area under the different testing voltages to obtain brightness values of the flawed pixel unit and the normal pixel units;

S13: calculating brightness averages of all of the pixel units in the sample pixel area under said different testing voltages;

S14: calculating ratios of the brightness value of the flawed pixel unit to the brightness averages and creating suitable brightness threshold values corresponding to the testing voltages according to the ratios, so as to create and save a lookup table of brightness threshold value;

S21: applying voltage to a pixel array under test;

S22: detecting brightness value of each pixel unit;

S23: calculating an average of brightness values of the pixel units in each pixel area;

S24: calculating a ratio of the brightness value of each pixel unit to the average;

S25: detecting voltage value of each pixel area under test;

S26: looking up a corresponding brightness threshold value from the lookup table saved in a saving module according to the voltage value of each pixel area under test; and

S27: comparing the ratio obtained from the step S24 with the brightness threshold value obtained from the step S26.

In one embodiment of the present invention, the brightness threshold value is larger than the ratio of the brightness value of the flawed pixel unit to the brightness average.

In one embodiment of the present invention, when the ratio is smaller than the brightness threshold value, the pixel unit corresponding to the ratio is a flawed pixel unit.

In one embodiment of the present invention, the brightness threshold value is smaller than the ratio of the brightness value of the flawed pixel unit to the brightness average.

In one embodiment of the present invention, when the ratio is larger than the brightness threshold value, the pixel unit corresponding to the ratio is a flawed pixel unit.

The present invention further provides a pixel array inspection apparatus comprising:

a charging module that is used to apply a testing voltage to a known sample pixel area containing a flawed pixel unit and normal pixel units and save the testing voltage value, and the charging module is also used to apply a voltage to each pixel area of a pixel array under test;

a first detecting module that is used to detect brightness value of each pixel unit in the sample pixel area after charged with the testing voltage, and the first detecting module is also used to detect brightness values of the pixel units of each pixel area of the pixel array under test;

a first calculating module connected to the first detecting module and used to receive the brightness value detected by the first detecting module and calculating an average of the brightness values of the pixel units within the sample pixel area or within each of the pixel areas under test;

a second calculating module connected to the charging module, the first detecting module and the first calculating module, used to receive the brightness value of the flawed pixel unit detected by the first detecting module, the average of the brightness values of the pixel units within the sample pixel area calculated by the first calculating module and the testing voltage value of the charging module, used to calculate a ratio of the brightness value of the flawed pixel unit to the average of the brightness values of the pixel units within the sample pixel area calculated by the first calculating module and to create a lookup table of brightness threshold value by creating suitable brightness threshold values corresponding to different testing voltages according to the ratios and the testing voltages of the sample pixel area that are corresponding to the ratios, respectively;

a saving module connected to the second calculating module and used to save the lookup table of brightness threshold value created by the second calculating module;

a second detecting module connected to the pixel array, and the second detecting module is used to detect the value of the voltage applied by the charging module to each of the pixel areas under test;

a third calculating module connected to the first detecting module and the first calculating module, and the third calculating module is used to receive the brightness values of the pixel units within each of the pixel areas under test detected by the first detecting module and the averages of brightness values of the pixel units within each of the pixel areas under test and to calculate a ratio of the brightness value of each pixel unit to the average;

a lookup module connected to the second detecting module and the saving module, and the lookup module is used to receive the voltage value of each pixel area under test detected by the second detecting module, and to look up a corresponding brightness threshold value corresponding to the voltage value of each pixel area under test from the lookup table of brightness threshold value saved by the saving module; and

a comparison module connected to the third calculating module and the lookup module, and the comparison module is used to receive the ratio of the brightness value of each pixel unit of the pixel area under test to the brightness average value calculated by the third calculating module, and to receive the corresponding brightness threshold value looked up by the lookup module, and further to compare the ratio of the brightness of the pixel unit of the pixel area under test to the brightness average with the corresponding brightness threshold value to determine if each of the pixel units is a flawed pixel unit.

In one embodiment of the present invention, the brightness threshold value calculated by the second calculating module is larger than the ratio of the brightness value of the flawed pixel unit to the brightness average value; and the comparison module is used to compare the ratio with the brightness threshold value, and if the ratio is smaller than the brightness threshold value, the pixel unit corresponding to the ratio is a flawed pixel unit.

In one embodiment of the present invention, the brightness threshold value calculated by the second calculating module is smaller than the ratio of the brightness value of the flawed pixel unit to the brightness average value; and the comparison module is used to compare the ratio with the brightness threshold value, and if the ratio is larger than the brightness threshold value, the pixel unit corresponding to the ratio is a flawed pixel unit.

The present invention mainly creates a lookup table of brightness threshold value according to the brightness values of normal pixel units and a flawed pixel unit within a sample pixel area, and thereby provides suitable criteria for identifying flawed pixels under different voltages, so as to reduce defects of check error and increase inspection accuracy.

### DESCRIPTION OF THE DRAWINGS

FIG. 1 is a schematic view of a substrate being inspected by an inspection apparatus for a pixel array in accordance with the present invention;

FIG. 2 is a block diagram of the inspection apparatus for the pixel array in accordance with the present invention;

FIG. 3 is a flow chart of an inspection method for a pixel array of a first embodiment of the present invention;

FIG. 4 is a flow chart of a step S10 in FIG. 3;

FIG. 5 is a flow chart of a step S20 in FIG. 3;

FIG. 6 is a lookup table of the inspection method for the pixel array of the first embodiment of the present invention;

FIG. 7 is a table of brightness values of a pixel area under an input voltage of 15V;

FIG. 8 is a table of brightness values of a pixel area under an input voltage of 12V;

FIG. 9 is a table of brightness values of a pixel area under an input voltage of 11V;

FIG. 10 is a flow chart of creating a lookup table of brightness threshold value according to a second embodiment of the inspection method for the pixel array of the present invention; and

FIG. 11 is a flow chart of inspecting a pixel area under test according to a second embodiment of the pixel array inspection method of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

The present invention is mainly applied to an array inspection apparatus in liquid crystal panel manufacturing process for inspecting defects of pixel arrays on a substrate.

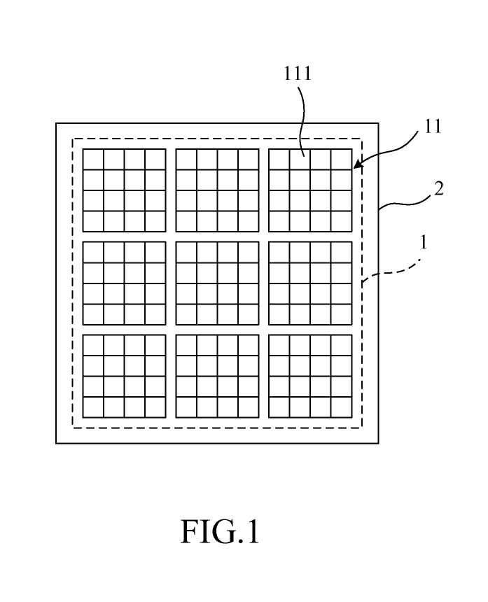

With reference to FIG. 1, FIG. 1 is a schematic view of a substrate being inspected by an inspection apparatus for a pixel array in accordance with the present invention, wherein a substrate 2 has a pixel array 1 formed thereon, and the pixel array 1 includes a plurality of pixel areas 11, and each of the pixel areas 11 has a plurality of pixel units 111.

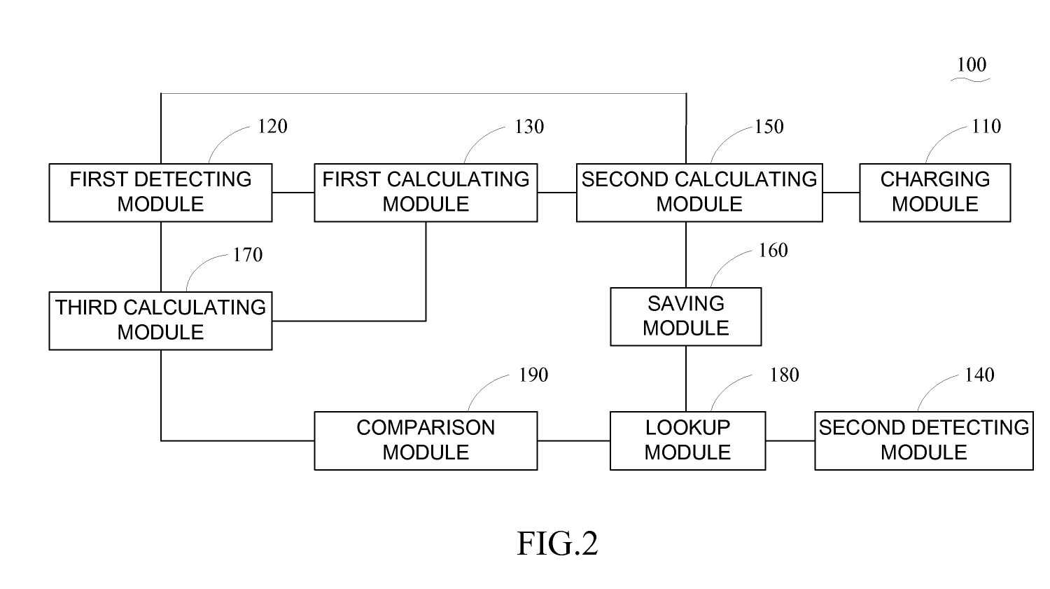

With reference to FIG. 2, FIG. 2 is a block diagram of an inspection apparatus 100 of the present invention for inspecting the pixel array 1. The inspection apparatus 100 has a charging module 110, a first detecting module 120, a first calculating module 130, a second detecting module 140, a second calculating module 150, a saving module 160, a third calculating module 170, a lookup module 180 and a comparison module 190.

The charging module 110 is used to electrically connected to the pixel array 1 and apply a voltage to each of the pixel areas 11 of the pixel array 1. The charging module 110 is also used to apply a testing voltage to a known sample pixel area containing a flawed pixel unit and normal pixel units and save the value of the testing voltage. The testing voltage value is within a range of voltage transmitted by a conducting wire connected to the sample pixel area.

The first detecting module 120 is used to detect brightness values of the pixel units 111 of each pixel area 11 of the pixel array 1 under test after charging by the charging module 110. The first detecting module 120 is also used to detect brightness value of each pixel unit in the sample pixel area after charged with the testing voltage.

The first calculating module 130 is connected to the first detecting module 120, and is used to receive the brightness value of each pixel unit detected by the first detecting module 120 and calculate an average of the brightness values of the pixel units within each pixel area. The first calculating module 130 is used to calculate the average of the brightness values of the pixel units within the pixel area 11 under test and the average of the brightness values of the pixel units within the sample pixel areas.

The second detecting module 140 is connected to the pixel array 1, and is used to detect the value of the voltage applied to each of the pixel areas 11 under test by the charging module 110.

The second calculating module 150 is connected to the charging module 110, the first detecting module 120 and the first calculating module 130, used to receive the brightness value of the flawed pixel unit detected by the first detecting module 120, the average of the brightness values of the pixel units within each of the pixel area calculated by the first calculating module 130 and the testing voltage value of the charging module 110. The second calculating module 150 calculates a ratio of the brightness value of the flawed pixel unit to the average of the brightness values of the pixel units within the sample pixel area calculated by the first calculating module 130 and creates a lookup table of brightness threshold value by creating suitable brightness threshold values corresponding to different testing voltages according to the ratios and the corresponding testing voltages of the sample pixel area. When the defect in the sample pixel area is a dark spot defect, the brightness threshold value is substantially larger than the ratio of the brightness value of the flawed pixel unit to the brightness average value. Preferably, by applying an identical testing voltage to different sample pixel area and calculating the ratios of the brightness values of the flawed pixel to the brightness average value, the brightness threshold value is decided as being larger than the maximum value among the ratios. When the defect in the sample pixel area is a bright spot defect, the brightness threshold value is substantially smaller than the ratio of the brightness value of the flawed pixel unit to the brightness average value. Preferably, by applying an identical testing voltage to different sample pixel area and calculating the ratios of the brightness values of the flawed pixel to the brightness average value, the brightness threshold value is decided as being smaller than the minimum value among the ratios.

The saving module 160 is connected to the second calculating module 150 and is used to save the lookup table of brightness threshold value created by the second calculating module 150.

The third calculating module 170 is connected to the first detecting module 120 and the first calculating module 130. The third calculating module 170 is used to receive the brightness values of the pixel units 111 within each of the pixel areas 11 under test detected by the first detecting module 120 and the averages of brightness values of the pixel units 111 within each of the pixel areas 11 under test, and to calculate a ratio R of the brightness value of each pixel unit 111 to the average value.

The lookup module 180 is connected to the second detecting module 140 and the saving module 160. The lookup module 180 is used to receive the voltage value of each of the pixel areas 11 under test detected by the second detecting module 140, and to look up a corresponding brightness threshold value corresponding to the voltage value of each pixel area 11 under test from the lookup table of brightness threshold value saved by the saving module 160.

The comparison module 190 is connected to the third calculating module 170 and the lookup table 180, and is used to receive the ratio R of the brightness value of each pixel unit 111 of the pixel area 11 under test to the brightness average value calculated by the third calculating module 170, and to receive the corresponding brightness threshold value looked up by the lookup module 180, and further to compare the ratio R of the brightness of the pixel unit 111 of the pixel area 11 under test to the brightness average with the corresponding brightness threshold value, and to determine if each of the pixel units 111 is a flawed pixel unit. When the pixel array has a dark spot defect, the pixel unit that has the ratio R smaller than the brightness threshold value is a flawed pixel unit; when the pixel array has a brightness spot defect, the pixel unit that has the ratio R larger than the brightness threshold value is a flawed pixel unit.

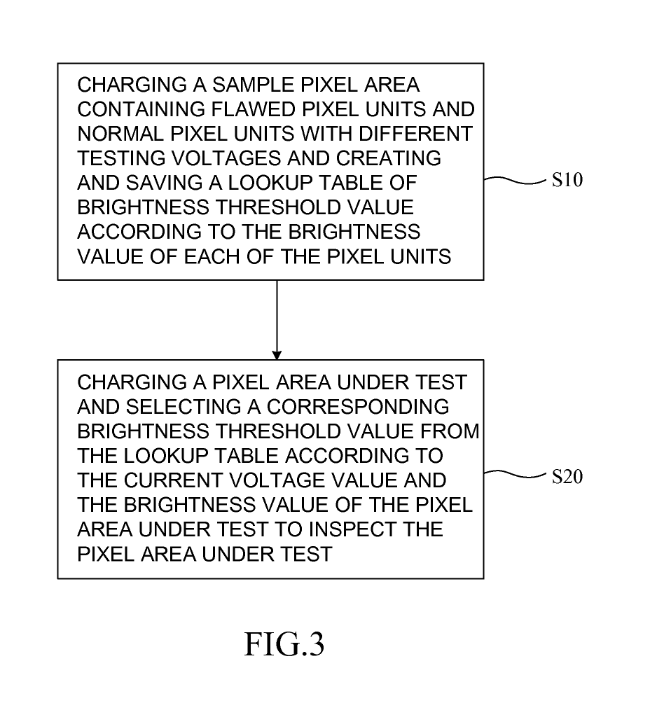

With reference to FIG. 3 and FIGS. 1, 2, 4 to 9, wherein FIG. 3 is a flow chart of an inspection method for a pixel array of a first embodiment of the present invention. The inspection method in this embodiment is for a pixel array having dark spot defect and comprises steps of:

S10: charging a sample pixel area containing flawed pixel units and normal pixel units with different testing voltages and creating and saving a lookup table of brightness threshold value according to the brightness value of each of the pixel units; and

S20: charging a pixel area under test and selecting a corresponding brightness threshold value from the lookup table according to the current voltage value and the brightness value of the pixel area under test to inspect the pixel area under test.

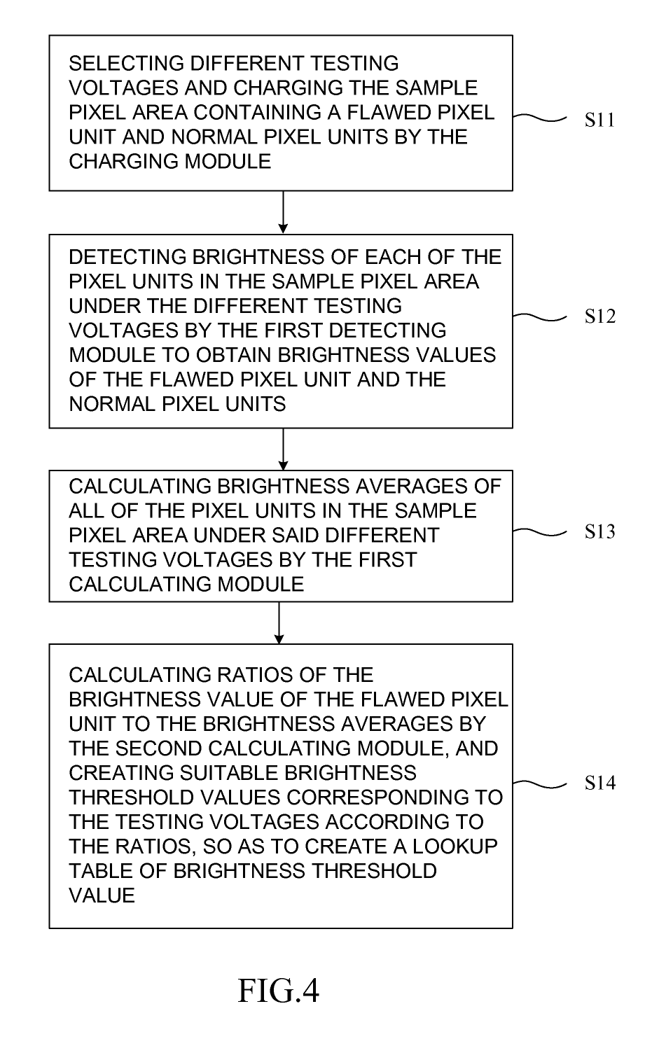

In more detail, with reference to FIG. 4, step S10 comprises steps of:

S11: selecting different testing voltages and charging the sample pixel area containing a flawed pixel unit and normal pixel units by the charging module 110, wherein the testing voltages are within a range of voltage transmitted by a conducting wire connected to the sample pixel area. In details, the charging module 110 firstly measure an input voltage V1 of an inputting end and an output voltage V2 of an outputting end of a conducting wire connected to an array substrate having the sample pixel area, wherein according to different sizes of the array substrate, the same input voltage V1 will results in different output voltage V2. The charging module 110 then decides a selecting range for a testing voltage according to the input voltage V1 and the different output voltages V2. Preferably, the charging module 110 selects the minimum output voltage V2 as the minimum value Vmin of the testing voltage, which means Vmin≦Vt≦V1, and then selects a plurality of voltage values between Vmin and V1 as the testing voltages. The number of the selected testing voltages can be decided according to the size of the substrate or the difference between Vmin and V1, for example, the larger the size of the liquid crystal panel is, the larger the selecting number of the testing voltage is.

S12: detecting brightness of each of the pixel units in the sample pixel area under the different testing voltages by the first detecting module 120 to obtain brightness values of the flawed pixel unit and the normal pixel units.

S13: calculating brightness averages of all of the pixel units in the sample pixel area under said different testing voltages by the first calculating module 130.

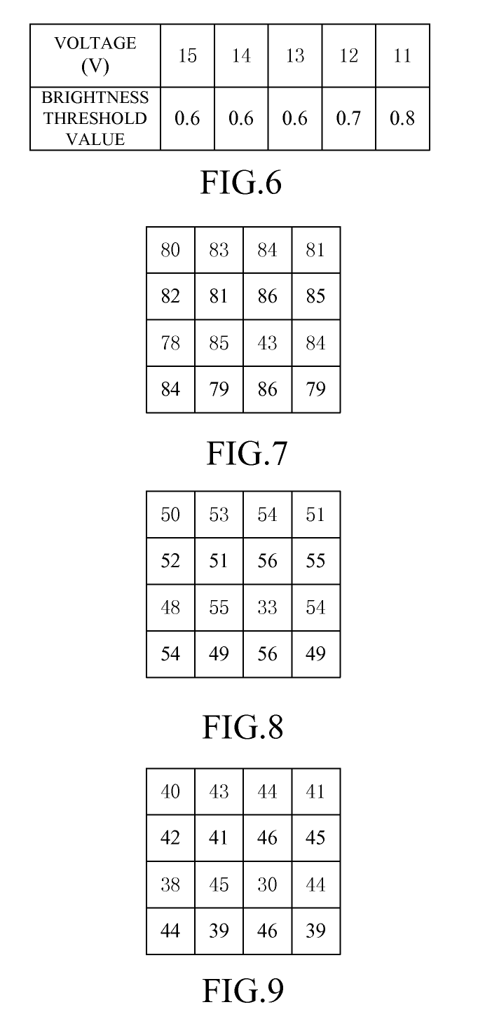

S14: calculating ratios of the brightness value of the flawed pixel unit to the brightness averages by the second calculating module 150, and creating suitable brightness threshold values S corresponding to the testing voltages according to the ratios, so as to create a lookup table of brightness threshold value. Preferably, the brightness threshold value S is substantially larger than the ratio of the brightness value of the flawed pixel unit to the brightness average. More preferably, by applying an identical testing voltage to different sample pixel area and calculating the ratios of the brightness values of the flawed pixel to the brightness average value, the brightness threshold value S is decided as being larger than the maximum value among the ratios. With reference to FIG. 6, FIG. 6 is a lookup table of the inspection method for the pixel array of the first embodiment of the present invention. In this embodiment, the brightness threshold value corresponding to testing voltage of 15V to 13V is 0.6; the brightness threshold value corresponding to testing voltage of 12V is 0.7; the brightness threshold value corresponding to testing voltage of 11V is 0.8. The lookup table of brightness threshold value is saved by the saving module 160.

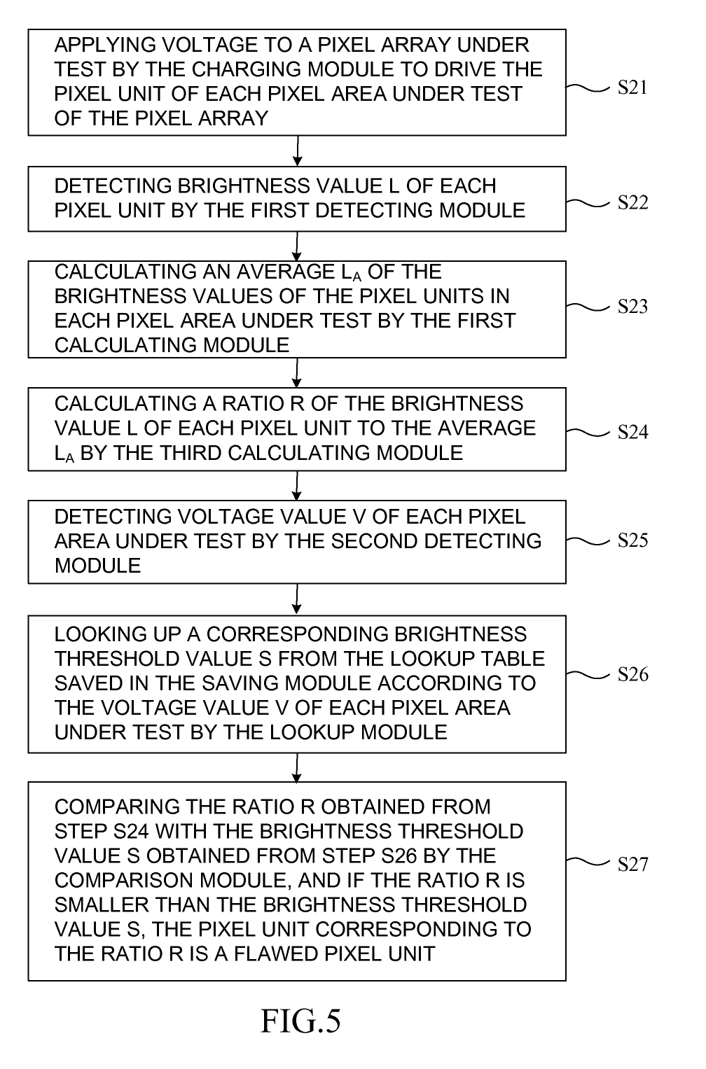

In more detail, with reference to FIG. 5, the step S20 includes steps of:

S21: applying voltage to a pixel array 1 under test by the charging module 110 to drive the pixel unit 111 of each pixel area 11 under test of the pixel array 1.

S22: detecting brightness value L of each pixel unit 111 by the first detecting module 120. With reference to FIG. 7, FIG. 7 is a table of brightness values of pixel units 111 of one of the pixel areas 11 detected by the first detecting module 120 under an input voltage of 15V.

S23: calculating an average L_{A} of the brightness values of the pixel units 111 in each pixel area 11 under test by the first calculating module 130. In FIG. 7, the average L_{A} of the brightness values of the pixel units 111 in the pixel area 11 under test calculated by the first calculating module 130 is 80.

S24: calculating a ratio R of the brightness value L of each pixel unit 111 to the average L_{A} by the third calculating module 170.

S25: detecting voltage value V of each pixel area 11 under test by the second detecting module 140.

S26: looking up a corresponding brightness threshold value S from the lookup table saved in the saving module 160 according to the voltage value V of each pixel area 11 under test by the lookup module 180.

S27: comparing the ratio R obtained from the step S24 with the brightness threshold value S obtained from the step S26 by the comparison module 190. If the ratio R is smaller than the brightness threshold value S, the pixel unit corresponding to the ratio R is a flawed pixel unit.

With reference to FIGS. 7 to 9, FIGS. 7 to 9 respectively show the tables of brightness values of a pixel area under input voltage of 15V, 12V and 11V. As for the pixel area 11 under input voltage of 15V, according to the lookup table in FIG. 6, the lookup module 180 selects the brightness threshold value of 0.6 as the criterion of determine if each of the pixel units 111 in the pixel area 11 has defects. In a similar way, as for the pixel area 11 under input voltage of 11V shown in FIG. 9, the lookup module 180 selects a brightness threshold value of 0.8, and the brightness average L_{A} of the pixel units 111 calculated by the first calculating module 130 is 41.6875. When the third calculating module 170 calculates that the ratio R of the brightness value L of one of the pixel units 111 to the brightness average L_{A} is 30/41.6875=0.7196, this pixel unit 111 then is inspected as a flawed pixel unit by the comparison module 190. Since the present invention correspondingly lifts the brightness threshold value S from 0.6 to 0.8 to raise the criterion for identifying when the input voltage is decreased from 15V to 11V, the inspection apparatus still can identify if each of the pixel units 111 has any defect under the condition of small difference of brightness between the pixel units while the input voltage becomes smaller.

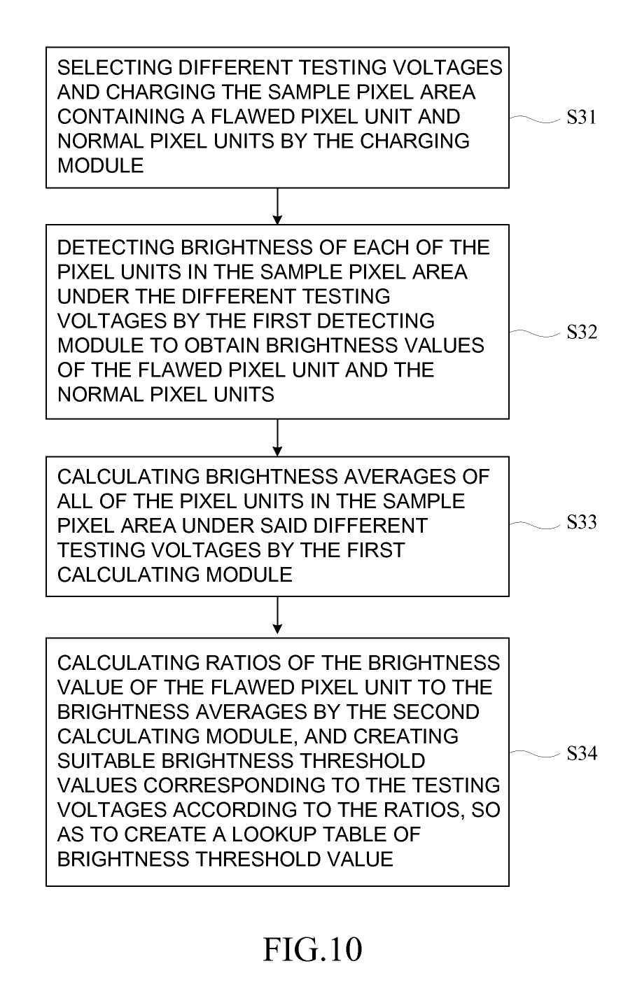

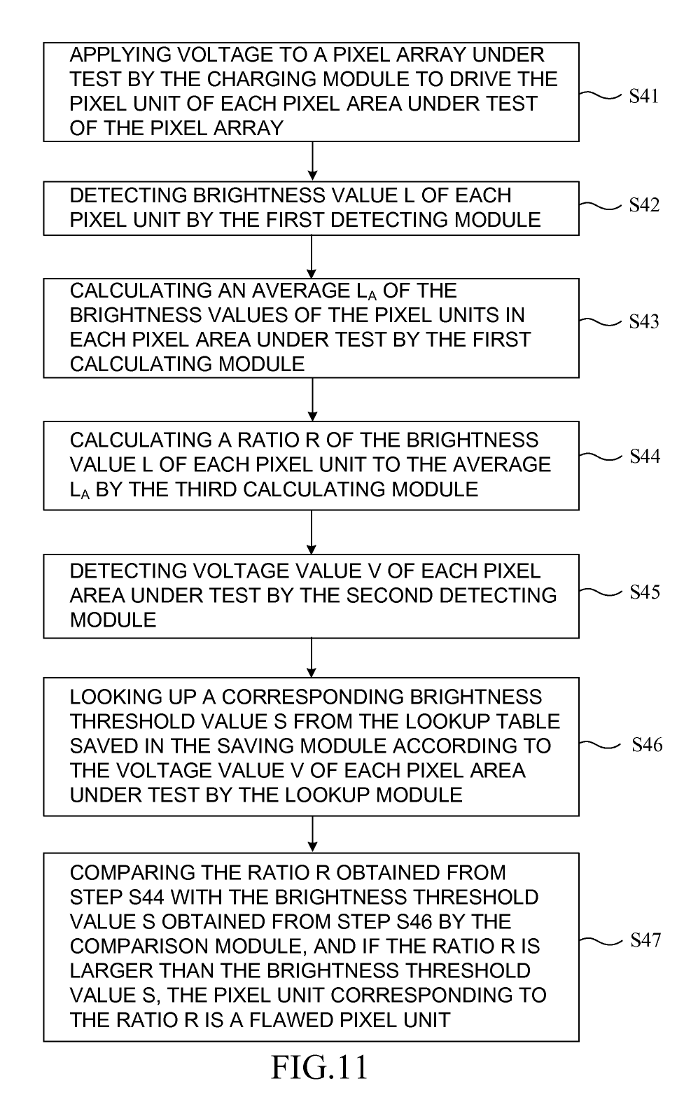

With reference to FIGS. 10 and 11, showing flow charts of the inspection method for the pixel array of a second embodiment of the present invention, the inspection method in this embodiment is for a pixel array having bright spot defects, wherein the steps of S31 to S33 and the steps of S41 to S46 are correspondingly the same as the steps of S11 to S13 and the steps of S21 to S26, the difference between this embodiment and the first embodiment is: in the step S34, the brightness threshold value S is substantially smaller than the ratio of the brightness value of the flawed pixel unit to the brightness average. And preferably, by applying an identical testing voltage to different sample pixel area and calculating the ratios of the brightness values of the flawed pixel to the brightness average value, the brightness threshold value S is decided as being smaller than the minimum value among the ratios. In the step S47, the comparison module 190 compares the ratio R obtained from the step S44 with the brightness threshold value S obtained from the step S46. If the ratio R is larger than the brightness threshold value S, the pixel unit corresponding to the ratio R is a flawed pixel unit.

With the foregoing description, comparing with the conventional inspection method for the pixel array that only sets a single threshold value as the criterion for identifying and leads to a condition of check error or being unable to detect defects during the inspection process, the present invention firstly creates a lookup table, and selects different brightness threshold values as defect-identifying criteria to correspondingly meet different voltages, so as to reduce detection error and enhance inspection accuracy, and reduce unnecessary cost on maintaining time, and thereby is contributive to increase production capacity.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An inspection method for a pixel array, wherein the inspection method for the pixel array comprises steps of:
S10: charging a sample pixel area containing flawed pixel units and normal pixel units with different testing voltages and creating and saving a lookup table of brightness threshold value according to the brightness value of each of the pixel units; and
S20: charging a pixel area under test and selecting a corresponding brightness threshold value from the lookup table according to the current voltage value and the brightness value of the pixel area under test to inspect the pixel area under test.

2. The inspection method for the pixel array as claimed in claim 1, wherein the step S10 comprises:
S11: selecting different testing voltages to charge the sample pixel area containing a flawed pixel unit and normal pixel units;
S12: detecting brightness of each of the pixel units in the sample pixel area under said different testing voltages to obtain brightness value of the flawed pixel unit and the normal pixel units;
S13: calculating brightness averages of all of the pixel units in the sample pixel area under said different testing voltages; and
S14: calculating ratios of the brightness value of the flawed pixel unit to the brightness averages and creating suitable brightness threshold values corresponding to the testing voltages according to the ratios, so as to create and save a lookup table of brightness threshold value.

3. The inspection method for the pixel array as claimed in claim 2, wherein the step S20 comprises:
S21: applying voltage to a pixel array under test;
S22: detecting brightness value of each pixel unit;
S23: calculating an average of brightness values of the pixel units in each pixel area;
S24: calculating a ratio of the brightness value of each pixel unit to the average;
S25: detecting voltage value of each pixel area under test;
S26: looking up a corresponding brightness threshold value from the lookup table saved in a saving module according to the voltage value of each pixel area under test; and
S27: comparing the ratio obtained from the step S24 with the brightness threshold value obtained from the step S26.

4. The inspection method for the pixel array as claimed in claim 3, wherein in the step S14, the brightness threshold value is larger than the ratio of the brightness value of the flawed pixel unit to the brightness average.

5. The inspection method for the pixel array as claimed in claim 4, wherein in the step S27, when the ratio is smaller than the brightness threshold value, the pixel unit corresponding to the ratio is a flawed pixel unit.

6. The inspection method for the pixel array as claimed in claim 3, wherein in the step S14, the brightness threshold value is smaller than the ratio of the brightness value of the flawed pixel unit to the brightness average.

7. The inspection method for the pixel array as claimed in claim 6, wherein in the step S27, when the ratio is larger than the brightness threshold value, the pixel unit corresponding to the ratio is a flawed pixel unit.

8. An inspection method for a pixel array, wherein the inspection method for the pixel array comprises steps of:
S11: selecting different testing voltages to charge a sample pixel area containing a flawed pixel unit and normal pixel units, and the testing voltages are within a range of voltage transmitted by a conducting wire connected to the sample pixel area;
S12: detecting brightness of each of the pixel units in the sample pixel area under the different testing voltages to obtain brightness values of the flawed pixel unit and the normal pixel units;
S13: calculating brightness averages of all of the pixel units in the sample pixel area under said different testing voltages;
S14: calculating ratios of the brightness value of the flawed pixel unit to the brightness averages and creating suitable brightness threshold values corresponding to the testing voltages according to the ratios, so as to create and save a lookup table of brightness threshold value;
S21: applying voltage to a pixel array under test;
S22: detecting brightness value of each pixel unit;
S23: calculating an average of brightness values of the pixel units in each pixel area;
S24: calculating a ratio of the brightness value of each pixel unit to the average;
S25: detecting voltage value of each pixel area under test;
S26: looking up a corresponding brightness threshold value from the lookup table saved in a saving module according to the voltage value of each pixel area under test; and
S27: comparing the ratio obtained from the step S24 with the brightness threshold value obtained from the step S26.

9. The inspection method for the pixel array as claimed in claim 8, wherein in the step S14, the brightness threshold value is larger than the ratio of the brightness value of the flawed pixel unit to the brightness average.

10. The inspection method for the pixel array as claimed in claim 9, wherein in the step S27, when the ratio is smaller than the brightness threshold value, the pixel unit corresponding to the ratio is a flawed pixel unit.

11. The inspection method for the pixel array as claimed in claim 8, wherein in the step S14, the brightness threshold value is smaller than the ratio of the brightness value of the flawed pixel unit to the brightness average.

12. The inspection method for the pixel array as claimed in claim 11, wherein in the step S27, when the ratio is larger than the brightness threshold value, the pixel unit corresponding to the ratio is a flawed pixel unit.

13. An inspection apparatus for a pixel array, wherein the inspection apparatus for the pixel array comprises:
a charging module that is used to apply a testing voltage to a known sample pixel area containing a flawed pixel unit and normal pixel units and save the testing voltage value, and the charging module is also used to apply a voltage to each pixel area of a pixel array under test;
a first detecting module that is used to detect brightness value of each pixel unit in the sample pixel area after charged with the testing voltage, and the first detecting module is also used to detect brightness values of the pixel units of each pixel area of the pixel array under test;
a first calculating module connected to the first detecting module and used to receive the brightness value detected by the first detecting module and calculating an average of the brightness values of the pixel units within the sample pixel area or within each of the pixel areas under test;
a second calculating module connected to the charging module, the first detecting module and the first calculating module, used to receive the brightness value of the flawed pixel unit detected by the first detecting module, the average of the brightness values of the pixel units within the sample pixel area calculated by the first calculating module and the testing voltage value of the charging module, used to calculate a ratio of the brightness value of the flawed pixel unit to the average of the brightness values of the pixel units within the sample pixel area calculated by the first calculating module, and to create a lookup table of brightness threshold value by creating suitable brightness threshold values corresponding to different testing voltages according to the ratios and the testing voltages of the sample pixel area that are corresponding to the ratios, respectively;
a saving module connected to the second calculating module and used to save the lookup table of brightness threshold value created by the second calculating module;
a second detecting module connected to the pixel array, and the second detecting module is used to detect the value of the voltage applied by the charging module to each of the pixel areas under test;
a third calculating module connected to the first detecting module and the first calculating module, and the third calculating module is used to receive the brightness values of the pixel units within each of the pixel areas under test detected by the first detecting module and the averages of brightness values of the pixel units within each of the pixel areas under test and to calculate a ratio of the brightness value of each pixel unit to the average;
a lookup module connected to the second detecting module and the saving module, and the lookup module is used to receive the voltage value of each pixel area under test detected by the second detecting module, and to look up a corresponding brightness threshold value corresponding to the voltage value of each pixel area under test from the lookup table of brightness threshold value saved by the saving module; and
a comparison module connected to the third calculating module and the lookup module, and the comparison module is used to receive the ratio of the brightness value of each pixel unit of the pixel area under test to the brightness average value calculated by the third calculating module, and to receive the corresponding brightness threshold value looked up by the lookup module, and further to compare the ratio of the brightness of the pixel unit of the pixel area under test to the brightness average with the corresponding brightness threshold value to determine if each of the pixel units is a flawed pixel unit.

14. The inspection apparatus for the pixel array as claimed in claim 13, wherein the brightness threshold value calculated by the second calculating module is larger than the ratio of the brightness value of the flawed pixel unit to the brightness average value; and the comparison module is used to compare the ratio with the brightness threshold value, and if the ratio is smaller than the brightness threshold value, the pixel unit corresponding to the ratio is a flawed pixel unit.

15. The inspection apparatus for the pixel array as claimed in claim 13, wherein the brightness threshold value calculated by the second calculating module is smaller than the ratio of the brightness value of the flawed pixel unit to the brightness average value; and the comparison module is used to compare the ratio with the brightness threshold value, and if the ratio is larger than the brightness threshold value, the pixel unit corresponding to the ratio is a flawed pixel unit.
